(19) United States
(12) Patent Application Publication
(10) Pub. No.: US 2005/0075768 A1
(43) Pub. Date: Apr. 7, 2005

(54) Multipurpose multifunction interface device for automotive diagnostics

(75) Inventors: William Nicholson, Waukesha, WI (US); Timothy Ledger, Elkhorn, WI (US); Thomas M. Fudali, McHenry, IL (US)

Correspondence Address: McDERMOTT, WILL & EMERY, 600 13th Street, N.W., Washington, DC, 20005-3096, US

(73) Assignee: SNAP-ON TECHNOLOGIES, INC. AUTOLOGIC, L.L.C.

(21) Appl. No.: 10/676,092

(22) Filed: Oct. 2, 2003

(51) Int. Cl. G06F 19/00

(52) U.S. Cl. 701/29; 422/83; 701/33

(57) ABSTRACT

A multipurpose multifunctional (M/M) interface device system comprises one or more system ports configured to couple to a system to be diagnosed; one or more diagnostic ports configured to couple to at least one diagnostic system; a set of power management modules configured to provide a full power level and a reduced power level; and a main processor module configured to control communications between the system ports and the diagnostic ports. The main processor module selectively transitions the M/M interface device between a standby mode at the reduced power level and an operational mode at the full power level in response to prescribed criteria. The device is useful in vehicle diagnostics, such as gas analyses, and other applications.

### CROSS REFERENCE TO RELATED APPLICATIONS

This application is related to co-pending U.S. patent application Ser. No. 10/454,825, filed Jun. 5, 2003, Case Docket No. 66396-031, entitled PORTABLE VEHICLE EXHAUST ANALYZER MODULE, and incorporated herein by reference.

### TECHNICAL FIELD

Diagnostic systems and methods for use in monitoring and analyzing a variety of automotive parameters or other parametric data.

### BACKGROUND

A variety of systems and subsystems lend themselves to being diagnosed, monitored and tested by external equipment and systems. Generally, external equipment and systems may be considered systems that are not part of the system or subsystem being diagnosed, tested or monitored (collectively referred to as “diagnostic systems” herein).

There are many contexts in which diagnostic systems are applied. Examples are, laboratories, design environments, manufacturing facilities, and automotive development, testing and maintenance shops. Such diagnostic systems may be large stationary systems or small handheld systems, depending on a variety of factors.

In order for a system being diagnosed to communicate with an external diagnostic system, an interface must be provided between the two. The interface could be a part of the diagnostic system or a part of the system to be diagnosed. In other forms, the interface could be a standalone system or a device that couples between the two systems.

Interface devices tend to be specifically configured either for the system to be diagnosed, the diagnostic system, or both. In other words, they tend to be rigid in design and narrow in application. Such interface devices are frequently passive devices that allow signals to be passed between the two systems. These interface devices offer little in the way of services or resources (e.g., power) to the system to be tested or diagnostic systems. And, they tend to offer only a narrowly focused set of communications ports, tailored to a specific diagnostic utility.

Since such interface devices tend to be so narrowly focused, several interface devices are often required to interface several systems taking part in the diagnosis, testing or monitoring. This tends to be cumbersome and inefficient, and can significantly complicate the diagnosis environment and process. Diagnostic systems have become smaller, as one example a collection of components mounted to one or more printed circuit boards (PCBs). However, these diagnostic systems remain largely application or type specific, as do their corresponding interface devices. Therefore, existing diagnostic solutions continue to require multiple PCBs and interface devices, since these are not provided in one package.

### SUMMARY

A multipurpose multifunctional (M/M) interface device comprises a plurality of communication ports, including one or more system ports configured to couple to a system to be diagnosed and one or more diagnostic ports configured to couple to at least one diagnostic or host system. A set of power management modules is included and configured to provide a full power level and a lower (or reduced) power level. A main processor module is configured to control communications between the system ports and the diagnostic ports and to selectively transition the M/M interface device between a standby mode at the lower power level and an operational mode at the full power level.

Transition of the M/M device from the standby mode to the operational mode is accomplished in response to an occurrence of at least one of a set of power up trigger events, wherein the set of power up trigger events includes activity on at least one of the diagnostic ports or system ports. The one or more diagnostic ports may include a set of serial diagnostic ports, and the set of power up trigger events may include activity on at least one of the set of serial diagnostic ports. The set of power up trigger events may additionally, or alternatively, include a restoration of full power.

A transition of the M/M device from the operational mode to the standby mode is accomplished in response to the occurrence of at least one of a set of power down trigger events that may include inactivity on at least one of the diagnostic ports or system ports for a predetermined period of time. The set of power down trigger events may additionally, or alternatively, include a loss of full power.

The set of power management modules may include a main power module configured to provide the high power level from at least one external power source. The set of power management modules may include a battery power module configured to provide at least one of the high power level and the lower power level from at least one battery. And, the set of power management modules may include a battery charger. At least one internal rechargeable battery may be included as part of the battery power module, wherein the battery charger may then be configured to charge the internal battery at a fast rate when coupled to an external power source that has a voltage about equal to or greater than a voltage rating of the internal battery, and at a slower rate when the external power source has a voltage of substantially less than the voltage rating of the internal battery. The battery charger may also be configured to charge an external battery coupled to the M/M interface device via a power port.

The M/M interface device may include one or more thermal sensors and the battery power module may be configured to vary the charge rate as a function of an internal temperature of the M/M device. The M/M device may also include other sensors, such as humidity sensors, which may also impact the operational of the M/M device, for example, under the control of the main processor module. The M/M interface device may include sensors to monitor current environmental signals whose readings may be used for monitoring or for compensating other signals for ambient conditions.

### BRIEF DESCRIPTION OF THE DRAWINGS

The drawing figures depict illustrative embodiments by way of example, not by way of limitations. In the figures, like reference numerals refer to the same or similar elements.

FIG. 1 is a top level block diagram of a multipurpose multifunction interface device.

FIG. 2 is a block diagram of the multipurpose multifunctional interface device of FIG. 1 depicting a representative set of communications ports.

FIG. 3 through FIG. 5 is a set of figures of a flexible gas analyzer including the multifunctional interface device of FIG. 1

### DETAILED DESCRIPTION OF THE ILLUSTRATIVE EMBODIMENTS

An illustrative embodiment of a multipurpose multifunction interface device (M/M interface device) provides an interface for use between one or more pieces of diagnostic, test, maintenance or service equipment or systems or the like, or some combination thereof (collectively referred to as “diagnostic equipment”) and at least one system to be diagnosed, analyzed, maintained or monitored. For illustrative purposes, the M/M interface device supports communications with a variety of analog and digital devices, monitors and adjusts to its own environment, includes battery management functionality, and is relatively compact in physical size.

In the illustrative embodiment, the M/M interface device is applied in the context of vehicle diagnostics, test, maintenance, monitoring or analysis. In such a context, the M/M interface device may provide an interface between a vehicle or a subsystem thereof and one or more diagnostic (or host) systems, such as a portable gas analyzer, onboard diagnostics system, diesel smoke meter, OBD II scan tools, engine analyzer, bar code scanner, gas cap tester, or the like. However, it should be appreciated that, with its various types of input and output ports, the M/M interface device may be programmed to accept inputs for any of a number of types of parameters, i.e., from other types of devices or parametric systems. Other types of diagnostic equipment are also known in this art, the types, makes, and models of them are far too numerous to list here.

To achieve a compact size, the M/M interface device may be implemented as a set of components surface mounted on a multi-layer printed circuit board (PCB). Other configurations could also be used. The M/M interface device may be integral with the diagnostic equipment, provided as a standalone module configured to couple between one or more vehicles and one or more diagnostic systems, or it could be integral with a vehicle.

In this context, the M/M interface device may be configured to measure vehicle engine speed by at least one of three means: (1) an inductive connection to either a vehicle ignition high voltage, such as a spark plug wire, or a low voltage, such as a 12V ignition coil primary voltage; (2) a radio frequency (RF) antenna or probe configured to detect interference experienced within the high voltage portion of an ignition system; and (3) connection to a vehicle on-board diagnostic (OBD) system. The RF antenna/probe may be as simple as a piece of insulated wire hanging in free air proximate to the vehicle's engine. All engine speed revolutions per minute (RPM) measurements are microprocessor controlled to ensure precise, stable measurements.

Since, RPMs can sometimes be difficult to measure, typically, an RPM sensor, such as the inductive connection mentioned above, is clamped around the spark plug wire. Even still, often times the RPM signal may be too weak for traditional circuit to measure. To overcome this issue, the M/M interface device may include a software controlled potentiometer that adjusts the gain on the RPM circuits for weak RPM signals. In such a case, the RPM gain is continuously adjusted until a valid RPM signal is detected.

The M/M interface device includes at least one microprocessor that controls its plurality of RS-232 communications ports. A first RS-232 communications port is used as an input/output (I/O) interface for a host system (e.g., external display, PDA, PC or other computer). A second RS-232 communications port is configured to act as an I/O port for an OBD interface, in this embodiment a vehicle OBD interface. And, a third RS-232 port may be provided as an interface to the diagnostic equipment (e.g., gas analyzer). The M/M interface device provides a method for devices with only one communications port, such as a PDA, to easily communicate over several communications ports simultaneously. The M/M interface device also includes at lease one universal serial bus (USB) interface port, also used to interface with a host device or system, such as a laptop, PDA, PC, or other external system. The USB port may be microprocessor controlled by a USB processor module, discussed in more detail below. Through these ports, the M/M interface device enables an easy interface for vehicle signals which are not available in an analog manner to systems which require such signals in an analog form.

The M/M interface device may be configured to power multiple external low voltage devices, such as a personal digital assistant (PDA), monitor, gas analyzer or other external diagnostic devices. The M/M interface device also includes means for charging its internal 12V battery and being powered from either the internal battery source or external sources, as power inputs. Such external power input sources may include automotive vehicle battery with a voltage of about 12V or from a 120V AC to 12V DC power supply.

The M/M interface device monitors its own temperature and varies the battery charge rate and the power to certain devices based on its internal environment. As a result, avoided is the problem of generating excessive heat from several M/M interface device electronics components simultaneously operating.

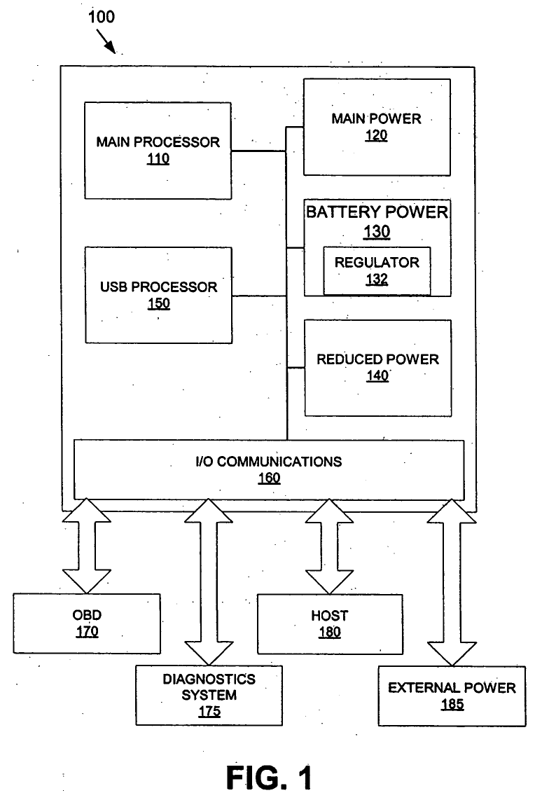

FIG. 1 is a top level block diagram of the modules that comprise the illustrative embodiment of a M/M interface device 100. In this embodiment, M/M interface device 100 includes a main processor module 110, main power module 120, battery power module 130, low power module 140, USB processor module 150, and input/output (I/O) module 160. Also shown in FIG. 1, are a representative set of devices with which the M/M interface device 100 may interface. These include a OBD system 170 (e.g., from a vehicle), a diagnostic system 175 (e.g., a gas analyzer), a host system 180 (e.g., a PDA), and an external power source 185 (e.g., a car battery).

Main Processor Module 110

The primary function of the main processor module 110 is to control the M/M interface device 100. This control includes control over the interfaces, power management functionality and its internal environment. The main processor module 110 communicates with external devices through the I/O module 160, as discussed more fully below.

The main processor module 110 of M/M interface device 100 includes at least one micro-processor or micro-controller, such as a Cygnal Integrated Products 8051F023 micro-controller. Other types of processors and controllers could also be used. The microprocessor module 110 includes or accesses local memory that stores the functional program for the M/M interface device, sometimes referred to as the main software. In the illustrative form, the M/M interface device 100 includes about 64K of programmable internal flash random access memory (RAM) and about 4.3K of fixed RAM. The memory is sized to accommodate, as a minimum, the size of the main software program, and any data or other programs that may need to be internally stored.

The power management functionality of the main processor module 110 controls the various available power modules, i.e., main power module 120, battery power module 130, and low power module 140. The main processor module 110 interfaces with these power modules to direct power usage and battery charging. Using these modules, the main processor module 110 controls the mode of the M/M interface device 100.

In the illustrative embodiment, the M/M interface device 100 has a full power operational mode and a lower (or reduced) power standby mode. In other embodiments, other modes could be defined, for example, modes that make available subsets of functionality or ports. In this illustrative embodiment, the M/M interface device 100 transitions between full power operation and lower power operation, as a function of port activity and of time with no user input or host communication. In other embodiments, the M/M interface device 100 could additionally, or alternatively, include an on/off switch for hard shut down or could transition based on other parameters of the M/M interface device 100, which may also be a function of the applied power levels.

Main Power Module 120

The primary function of the main power module 140 is to provide main or full power to the M/M interface device 100 to enable the full power operational mode. The main power module 120 can be configured to obtain power from external sources, internal sources, or some combination thereof.

Through communication with the main power module 120, the main processor module 110 can direct a transition from full power mode to standby (or lower power) mode as a function of one or more predetermined events. For example, the main processor module 110 could force the transition to standby mode in the absence of port activity for a predetermined amount of time or in response to inadequate power availability or quality. In such a case, the main processor module 110 directs the main power module 120 to cease providing full power. Other criteria, events or thresholds may also be defined and built into the logic of the main software to effect such mode transitions.

If in standby mode, and assuming port activity as a transition trigger or event, the main processor module 110 may transition out of standby mode in response to activity on the USB port, for example. That is, upon receipt of a signal on the USB port, the main processor module 110 tasks the main power module 120 to seek and provide full power to the M/M interface device 100. In response, the main power module 120 determines the availability of full power sources. For full power operation, M/M interface device 110 uses 12V DC, in the illustrative embodiment. Generally, the input voltage may be 12-15V, 13.4V at a current of less than about 4 A, with varistor over voltage protection and reverse bias protections, such power sources being known in the art.

Main power module 120 is configured to preferably interface with one or more external power sources, if available. If there is an available external power source, the main power module 130 is configured to power the M/M interface device 100 using the external power source. If there are multiple available external power sources, the main power module 120 may be configured to select among those sources based on predetermined criteria (e.g., power quality) or it may be configured to default to a given external power interface. If there is no external power source, then the main processor module 110 directs power be taken from the internal battery. In the illustrative embodiment, the battery is a 12V lead acid battery, but other types of batteries could be used, or, a plurality of internal batteries could be used. Once a full power 12V source has been chosen, the M/M interface device 100 transitions to its fully operational mode.

As examples, the main power module 120 may be configured to take full power from one or more of a variety of full power supply sources, including, but not limited to an internal battery, external power supply, cigarette lighter adapter, or a vehicle battery. Various other types of power sources could be used to individually, or collectively, provide the required 12V DC full power.

The main power module 120 includes a switching regulator controller that drives external N-channel power MOSFETs using a fixed frequency architecture to power the M/M interface device 100 even when the input voltage drops below 12 V. The MOSFETS combine with a small coil used to generate 12V for all M/M interface device components.

The main power module 120 may also be configured to include a thermal fuse for protection of the M/M interface device 100. In such a case, the fuse may be positioned between the interface to the external power source and the power output of the main power module 120, which feeds the components of the M/M interface device 100. If there is excessive current drawn internally, internal heat will rise and the thermal fuse will open once the temperature is about equal to or greater than a threshold temperature. The thermal fuse will reset automatically when the temperature falls below the threshold temperature.

Because the main processor module 110 has control over the full power mode via control over the main power module 120, the main processor module 110 also has control over the standby, reduced power mode. Transition to the standby mode is automatic once the main processor module 110 causes the main power module 120 to power down.

Battery Power Module 130

As with the main power module 120, the battery power module 130 is controlled by the main processor module 110. The primary function of the battery power module 130 is to provide a default full power option to the main processor module 110, should an external full power option not be available via the main power module 120. That is, if there is no external power source, the main processor module 110 switches from the main power module 120 to the battery power module 130 without interruption to the function of the M/M interface. The battery power module 130 may also include functionality to perform charging of the internal battery.

The M/M interface device 100 may also provide power to diagnostic equipment 175. For example, the battery power module 130 allows for a gas analyzer or other engine diagnostic equipment coupled to the M/M interface device 100 to be battery driven. Since a typical gas analyzer requires current in excess of 1 amp (A), the M/M interface device 100 enables a 12V 4.5 amp hours battery to be charged and used in a portable manner. The current is limited to 2 A in the illustrative embodiment.

The M/M interface device 100 main processor module 110 interfaces with the battery power module 130 to control selective charging of the 12V battery using several signals to determine if the 12V battery should be charged. For example, the M/M interface device 100 includes on-board thermal sensors that monitor on-board temperature. Should the on-board temperature indicate that the internal temperature is running above a threshold temperature, the battery power module 130 will not charge the M/M interface device's 12V battery. And, a fan may be activated to cool down the device. Opting out of charging the internal battery reduces the overall power consumption of the M/M interface device 100, and thus helps to maintain the temperature below the threshold temperature. In addition, the M/M interface device 100 includes a sensor for measuring current. The current sensor measures the total current used by the M/M interface device 100. When the current exceeds a preprogrammed maximum level, the main processor module 110 directs the battery power module 130 to terminate the battery charging function. Maintaining the current below a threshold level ensures that components not rated for currents above the threshold are not damaged.

Battery charging is accomplished using the switching regulator controller 132, previously discussed, which regulates charging as a function or temperature, current and available power. As implemented, the switching regulator controller 132 allows the internal 12V battery to be charged even when the M/M interface device 100 is powered externally by another battery with a voltage less than that of the M/M interface device battery. That is, the switching regulator controller 132 allows charging at either of two charge levels.

The first charge level provides a fast charge, when sufficient power is available from the power source. With fast charge enabled, the battery charges faster, as a higher charging voltage is applied. The second charge level is a slow charge mode, used when there is less than 12V available. The slow charge mode charges with a reduced voltage, which reduces the rate of charging of the M/M interface device battery and reduces any potential overcharge effect on the battery. By monitoring battery charging current, the switching regulator controller 132 can automatically switch to slow charge mode when the charging current falls below a current threshold, which may be preprogrammed. Additionally, the battery connection preferably includes the thermal fuse, which is opened in response to excess temperature or current, as previously discussed.

Reduced Power Module 140

A primary purpose of the reduced power module 140 is to power the main processor module 110 in the lower power or standby mode to preserve battery power. The M/M interface device 100, when not in full operation mode, remains in standby mode until a trigger event causes the main processor module 110 to cause the M/M interface device to transition to full power mode.

From the full power mode, the main processor module 110 interfaces with the reduced power module 140 and directs transition of M/M interface device 100 into the standby mode to conserve power, if there is a lack of activity for a threshold period of time or if adequate full power ceases to become available. While in the standby mode, the M/M interface device 100 monitors the RS-232 serial input lines and the USB input signals. When a signal is present on one of these lines, e.g., because an external device is attempting to communicate with the M/M interface device 100, the main processor module 110 transitions to full power mode and takes power from either an external source or the M/M interface device internal 12V battery source.

As configured in the illustrative embodiment, the M/M interface device 100 is activated from standby mode (i.e., reduced power mode) in response to a received signal on one of the M/M interface device ports, such as an RS-232 port or a USB port. As an example, once a signal is detected on the RS-232 port, the main software goes through a power up sequence, activating the M/M interface device power modules. Once the required 12V power source is activated by the main processor module 110, the diagnostic equipment (e.g., gas bench) goes through its own power up sequence. Once powered up, the M/M interface device 100 remains in a loop waiting for a host PC or diagnostic equipment to send commands, e.g. related to the diagnostics to be performed.

The reduced power module 140 includes a 5V regulator and a 3V regulator, in the illustrative embodiment. The current in the standby power mode is less than about 1 mA, thus there us no need for an on/off switch. The regulators provide the minimum amount of power necessary for the main processor 110 to keep running in standby mode. In the illustrative embodiment, these regulators are micro-power voltage regulators that maintain proper power regulation with an extremely low input-to-output voltage differential.

USB Processor Module 150

The USB processor module 150 may be provided to service USB interfaces such as an interface to a host system 180. In the illustrative embodiment, the USB processor module 150 includes a dedicated micro-controller. As an example, the USB processor module 150 may include a Cypress EZ USB 8051 based processor to facilitate connections to external devices configured for using the USB ports. In addition to standard USB interfaces, the USB processor module 150 may also be configured to perform OBDII interface functions for a OBDII serial port, also preferably provided as part of M/M interface device 100.

The USB processor module 150 can also provide the signal used to bring the M/M interface device 100 out of standby. Therefore, among other things, in the illustrative embodiment, the USB processor module 150 plays a role in transitioning the M/M interface device 100 out of standby mode. In response to a signal received by the M/M interface device 100 via a USB processor controlled port, the main processor module 110 effects the transition out of standby mode to full power operation.

Input/Output Section 160

The M/M interface device 100 includes a plurality of types of input and output ports, supporting a variety of functions. These ports allow the OBD 170 and diagnostics system 175 to pass signals, data and instructions through the M/M interface device 100 to one or more hosts system 180. These ports may also allow an external device, such as PDA or PC host system, which often does not include multiple serial ports, to have ready access to multiple serial ports via the M/M interface device 100.

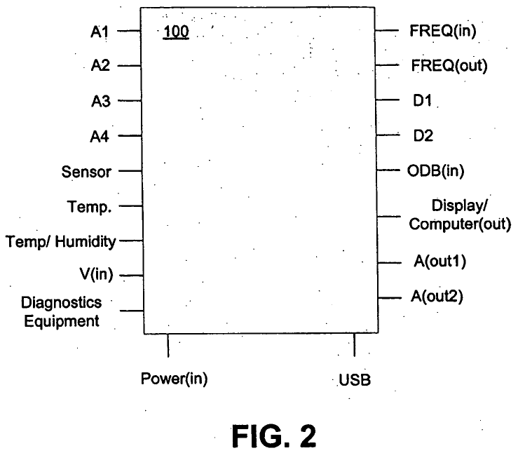

Although any of a variety of port configurations may be provided, depending largely on the context within which the M/M interface device 100 is applied, in the illustrative embodiment, as shown in FIG. 2, the M/M interface device 100 includes the following ports:

1. Frequency Input—This input port is provided to support RPM measurement. Using a standard application of analog signal conditioning circuitry, the main processor module 110 uses several software controlled potentiometers (known in the art) to give the M/M interface device 100 the ability to match the RPM of a particular vehicle. To accomplish this, the main software includes algorithms used to change the potentiometer values to adjust the gain and offset values of the analog circuitry. Such adjustments include the ability for a scaling down of relatively high RPM values, because some probes used in reading RPMs tend to lose the signal at high RPMs. The RPM input supports both an inductive RPM probe and a non-contact RPM probe, both of which are known in the art and discussed above.

2. Analog inputs—The M/M interface device 100 includes four designated analog input ports and four additional 0-5V input ports (A1-A4 in FIG. 2) for other analog signals. The designated ports include:
a) Sensor—One of the designated analog input ports is a 0-5V port used for external sensors, such as a sulfur dioxide (SO₂) or NO sensors.
b) Temperature Input—Another of the designated analog input ports is a 0-5V port for temperature input. The M/M interface device 100 includes circuitry to read from a three wire RTD input module, known in the art. One connector can be used for both RPM and temperature, if both are plugged in via a “Y” connector arrangement.
c) Ambient temperature and humidity—Another of the designated analog input ports is a 0-5V port for receiving ambient temperature and humidity readings. The M/M interface device 100 has both an onboard humidity sensor and an onboard temperature sensor to measure ambient conditions within the M/M interface device 100. These onboard sensors can be used to correct gases to ambient conditions for known formulas such as Dilution Correction Factor (DCF) and humidity for NOx (HCF) from the bar 97 standards.
d) Voltage Input—Another of the designated analog input ports is a 0-5V port for sensing the battery voltage.

3. Analog outputs—The M/N interface device 100 has two analog outputs (A(out1) and A(out2) in FIG. 2) to allow the M/M interface device 100 to output a signal proportional to any one of the signals the M/M interface device is capable of measuring. This allows the M/M interface device to interface to other types of equipment which have analog inputs which are frequently used in laboratory equipment.

4. Frequency Output—The M/M interface device 100 has a frequency output port that can output a frequency proportional to any signal the M/M interface device 100 measures, for example RPMs. In the illustrative embodiments, this is a 0-5K Hz, 0-5V output.

5. OBD Input—The OBD input port is a port used to read OBDII signals from an OBDII port of a system being diagnosed, such as those available on 1996 and newer vehicles. This port can be a DB9 computer port, using a dual RS-232 (e.g., 9 female pin) connector.

6. Digital Outputs—Digital output ports are used to turn on and off solenoids which are optionally included and used for controlling external devices. These outputs ports may also be used as digital output ports for generic purposes. Two isolated 32V DC ports capable of driving about 250 mA are provided in the illustrative embodiment.

7. Display/Computer Out—The M/M interface device 100 includes a display output port that can provide about 4-6.5V DC, at up to 2 amps. The exact voltage out is software controlled by the main processor module 110. This allows the M/M interface device to charge virtually any PDA display, for example. This port may be a generic DB9 port, using a dual RS-232 (e.g., 9 male pin) connector.

8. Diagnostic Equipment Out—The M/M interface device 100 has the ability to control a piece of 12V diagnostic equipment, such as a gas analyzer pump, with a pulse width modulated (PWM) signals, 0-2 amps. This allows the M/M interface device to support pneumatics control.

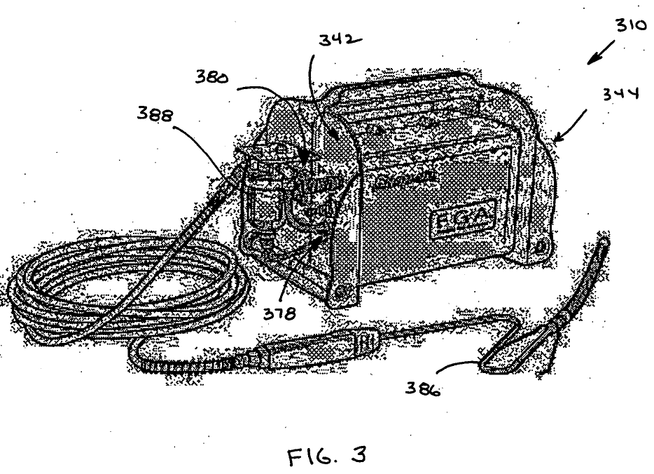

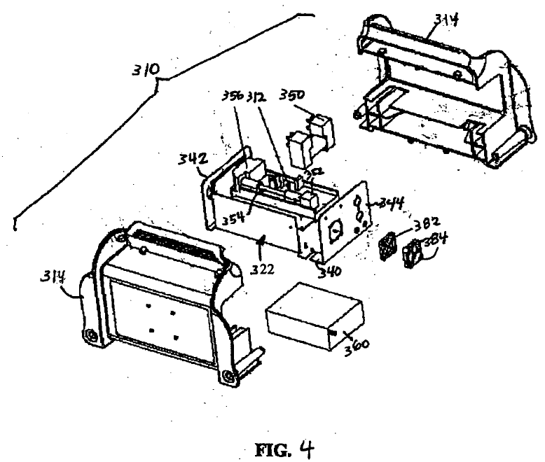

FIG. 3 through FIG. 5 show, as an example, one automotive diagnostic system within which M/M interface device 100 may be implemented in printed circuit board form, as M/M interface device 322. In these figures the automotive diagnostic system is a flexible gas analyzer (FGA) 310 from Snap-On Incorporated of Kenosha, Wis., described in co-pending U.S. patent application Ser. No. 10/454,825, filed Jun. 5, 2003, Case Docket No. 66396-031, entitled PORTABLE VEHICLE EXHAUST ANALYZER MODULE, and incorporated herein by reference. In general, the FGA 310 is used for the measurement of vehicle exhaust gases including carbon monoxide, hydrocarbons, carbon dioxide, oxygen, and oxides of nitrogen. The FGA 310 accepts exhaust gas samples from a vehicle under test and contains a sensor assembly 312 (as shown in FIG. 4) that provides measurements of the contents of the gas sample to a remote host computer (not shown), such as a pocket personal computer, laptop or desktop computer, or a specialty computer such as the MODIS™ modular diagnostic information system, also available from Snap-On Incorporated of Kenosha, Wis. In such a FGA, gas is received from a vehicle at a filtered fluid inlet 378 through a hose/probe 386 and a filter 388, available at a first end wall 342. Software including a vehicle exhaust diagnostic program is loaded on a remote host computer for allowing a technician to utilize the measurements produced by the module 310 to determine the contents of the vehicle exhaust.

The sensor assembly 312 is shown in exploded FIG. 4 and may preferably be a gas bench such as manufactured by Andros, Incorporated of Berkeley, Calif., and includes pump assembly 350, infrared source 352, sample tube 354, optical block 356, nitrous oxide sensor (not viewable), and oxygen sensor (not viewable). The control circuitry of the M/M interface device 322 is connected to and controls the sensor assembly 312, all of which is encased in housing 314. During operation, exhaust is received into the sensor assembly 312 and delivered into the sample tube 354 by the pump assembly 350. While the exhaust is in the sample tube 354, the infrared source 352 generates infrared light which travels through the exhaust in the sample tube 354, and is reflected into the optical block 356. The content of various gases (such as carbon monoxide, carbon dioxide, and hydrocarbons) can be determined by the response of different wavelengths of infrared light as they pass through the exhaust, as is known in the art. Exhaust then passes into the nitrous oxide sensor and the oxygen sensor, which are chemical sensors operable to determine the content of the respective gases in the exhaust. In this way, the content of five gases (as required in many government emissions programs) in exhaust emitted from a vehicle is determined. Exhaust then exits the sensor assembly 312 and is eventually released from the FGA 310 through an exhaust gas outlet 358.

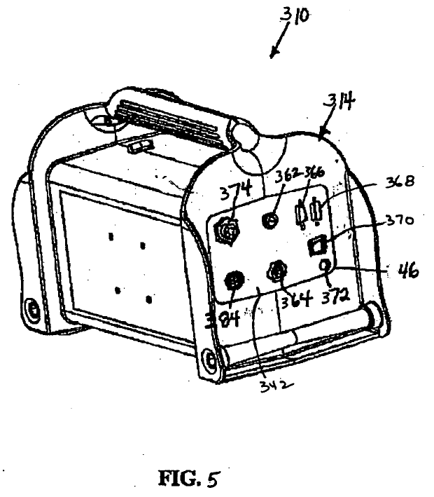

As is also shown in FIG. 4, a battery 360 is positioned within the housing enclosure 314 and connected to M/M interface device 322, which controls the battery and charging functions of the FGA 310 as previously discussed. Preferably, the battery 360 is rechargeable and, as shown best in FIG. 5, the FGA 310 includes a second end wall 344 having a power inlet plug 364 for recharging the battery via M/M interface device 322. The FGA 310 also includes a power outlet plug 362 so that the battery 360 can be used to power a remote computer used with the FGA 310, under control of M/M interface device 322. Alternatively, power can be provided to the FGA 310 through the power inlet plug 364 by either cigarette lighter receptacle in vehicle being tested or by a standard wall outlet, as examples, again accomplished via M/M interface device 322. Regardless of the source, 12-volt DC power is routed through the inlet power plug to FGA 310, via M/M interface device 322, which also may result in the battery 360 being charged.

The FGA 310 includes a fan 380 for drawing air through the housing enclosure 314. The fan 380 is connected to the control circuitry of the controller M/M interface device 322, which includes a thermometer. The M/M interface device 322 is programmed to operate the fan 380 so that a temperature within M/M interface device is regulated. In addition, in conjunction with the controller M/M interface device 322 and the fan 380, the internal battery charge rate is regulated from a high rate to low, based on temperature, battery voltage and current by the controller M/M interface device 322. The fan 380 is mounted on second end wall 344 and an air vent 384 and filter 382 are provided in the first end wall 342 to allow air to be drawn through the FGA 310 by the fan 380.

As shown best in FIG. 5, in addition to the power inlet plug 364 and a power outlet plug 362, the FGA 310 includes electrical/data connectors mounted on the first end wall 342 which are controlled by the communications module 160 of the M/M interface device 322. A set of signal output connectors comprise two DB9S connectors 366, 368, and communication between the sensor assembly 312 and an external host (e.g., PC) is in RS-232 format. A USB port 370 is also mounted in the end wall 342 and connected to the controller M/M interface device 322. A connector 374 for receiving vehicle information, e.g., tachometer and oil temperature readings, from the vehicle under test is secured to the end wall 342 and connected to the controller M/M interface device 322.

FIG. 3 through FIG. 5 show one context in which a M/M interface device can be implemented. Those skilled in the art will appreciate that the M/M interface device 322 could also be implemented in other contexts.

The embodiments described herein may include or be utilized with any appropriate voltage source, such as battery, an alternator and the like, providing any appropriate voltage, such as about 12V, about 42V, and the like or other DC or AC voltages provided by other sources.

The embodiments described herein may be used with any desired system or engine. Those systems or engines may comprise items utilizing fossil fuels, such as gasoline, natural gas, propane and the like, electricity, such as that generated by battery, magneto, solar cell and the like, wind and hybrids or combinations thereof. Those systems or engines may be incorporated into another system or systems, such as automobile, truck, boat or ship, motorcycle, generator, airplane and the like. The embodiments herein may also be used in non-vehicle applications that utilizes computer aided diagnostics, analysis, maintenance, test or the like of one or more systems, such as those systems using motors or engines.

While the foregoing has described what are considered to be the best mode and/or other illustrative embodiments, it is understood that various modifications may be made therein and that the invention or inventions may be implemented in various forms and embodiments, and that they may be applied in numerous applications, only some of which have been described herein. It is intended by the following claims to claim any and all modifications and variations that fall within the true scope of the inventive concepts.

1. A multipurpose multifunctional (M/M) interface device, comprising:
A. a plurality of communication ports, including:
1) one or more system ports configured to couple to a system to be diagnosed;
2) one or more diagnostic ports configured to couple to at least one diagnostic system;
B. a set of power management modules configured to provide, selectively, power at a full power level and a reduced power level; and
C. a main processor module configured to control communications between the system ports and the diagnostic ports, and to selectively transition the M/M interface device between a standby mode at the reduced power level and an operational mode at the full power level.

2. The device of claim 1, wherein a transition of the M/M device from the standby mode to the operational mode is responsive to an occurrence of at least one of a set of power up trigger events, wherein the set of power up trigger events includes activity on at least one of the diagnostic ports or system ports.

3. The device of claim 2, wherein the one or more diagnostic ports includes a set of serial diagnostic ports and the set of power up trigger events includes activity on at least one of the set of serial diagnostic ports.

4. The device of claim 2, wherein the set of power up trigger events includes a restoration of full power.

5. The device of claim 1, wherein a transition of the M/M device from the operational mode to the standby mode is responsive to an occurrence of at least one of a set of power down trigger events, wherein the set of power down events includes inactivity on at least one of the diagnostic ports or system ports for a predetermined period of time.

6. The device of claim 5, wherein the set of power down trigger events includes a loss of full power.

7. The device of claim 1, wherein the set of power management modules includes a main power module configured to provide the high power level from at least one external power source.

8. The device of claim 1, wherein the set of power management modules includes a battery power module configured to provide at least one of the high power level and the reduced power level from at least one internal battery.

9. The device of claim 1, wherein the set of power management modules includes a battery charger.

10. The device of claim 9, wherein the battery charger is configured to charge a rechargeable battery at a fast rate when the device is coupled to a power source of a voltage about equal to or greater than a voltage rating of the battery, and at a slow rate when the power source is of a voltage substantially less than the voltage rating of the battery.

11. The device of claim 9, wherein the battery charger is configured to charge an external battery coupled to the M/M interface device via a power port.

12. The device of claim 9, wherein the M/M interface device includes a thermal sensor, and the main processor module varies the charge rate as a function of an internal temperature of the M/M device measured by the thermal sensor.

13. The device of claim 1, wherein the set of power management modules is configured to provide power to at least one of the systems to be diagnosed or the diagnostic system.

14. The device of claim 1, wherein the main processor module is configured to generate analog signals from digital signals received from the one or more system ports, and to provide the analog signals to at least one diagnostic port.

15. A multipurpose multifunctional (M/M) interface device for vehicle diagnostics, comprising:
A. a plurality of communication ports, including:
1) one or more vehicle system ports configured to couple to at least one vehicle;
2) one or more diagnostic ports configured to couple to at least one vehicle diagnostic system;
B. a set of power management modules configured to provide a full power level and a reduced power level; and
C. a main processor module configured to control communications between the system ports and the diagnostic ports, the main processor module also configured to selectively transition the M/M interface device between a standby mode at the reduced power level and an operational mode at the full power level.

16. The device of claim 15, wherein the communications ports include an inductive port configured to couple to an ignition system of the at least one vehicle, and the main processor module is configured to measure revolutions per minute (RPM) of a vehicle engine as a function of a signal received by the inductive port.

17. The device of claim 15, wherein the communications ports include a radio frequency (RF) antenna port configured to couple to a high voltage portion of an ignition system of the at least one vehicle, and the main processor module is configured to measure RPMs of a vehicle engine as a function of a signal received by the RF port.

18. The device of claim 15, wherein the communications ports include an on-board diagnostics (OBD) port configured to couple to an OBD device of the at least one vehicle, and the main processor module is configured to measure RPM or other OBD signals of a vehicle engine as a function of a signal received by the OBD port.

19. The device of claim 15, wherein the main processor module and the set of power management modules are components mounted on a printed circuit board (PCB).

20. The device of claim 15, wherein the communication ports include one or more RS-232 ports, and the M/M device comprises a communication port processor configured for processing messages and data related to the one or more RS-232 ports.

21. The device of claim 15, wherein the set of power management modules is configured to power one or more external devices, including one or more of a display device, a personal digital assistant, or the at least one vehicle diagnostic system.

22. The device of claim 15, wherein the at least one vehicle diagnostic system includes a portable gas analyzer.

23. The device of claim 15, wherein the set of power management modules includes a battery charger configured to charge at least one battery at a fast rate when the device is coupled to an external power source that is of a voltage about equal to or greater than a voltage rating of the at least one battery, and at a slow rate when the device is coupled to an external power source that is of a voltage substantially less than the voltage rating of the at least one battery.

24. The device of claim 23, wherein the at least one battery includes an internal rechargeable battery.

25. The device of claim 15, wherein the main processor module is configured to generate analog signals from digital signals received from the one or more system ports, and to provide the analog signals to at least one diagnostic port.

26. The device of claim 15, further comprising a monitor configured to monitor the environmental conditions of the device and to adjust signals generated by the device in response to at least one of the environmental conditions exceeding a threshold value.
